(19) United States
(12) Patent Application Publication
(10) Pub. No.: US 2026/0340140 A1
(43) Pub. Date: Oct. 29, 2026

(54) Advanced Attribute Prioritized Checksum Tokenization System

(71) Applicant: Bank of America Corporation, Charlotte, NC (US)

(72) Inventors: Bikash Dash, Hyderabad (IN); Meera Lakshmi, Tamil Nadu (IN)

(73) Assignee: Bank of America Corporation, Charlotte, NC (US)

(21) Appl. No.: 19/187,555

(22) Filed: Apr. 23, 2025

(51) Int. Cl. G06F 21/57

(52) U.S. Cl. CPC G06F 21/577; G06F 2221/034

(57) ABSTRACT

Various aspects of the disclosure relate to securely communicating data via risk-based analysis of attributes of a data exchange transaction. For example, cloud-based point-of sale transactions, may be securely managed through an attribute-prioritized checksum tokenization mechanism that is integrated with a centralized secure access web gateway to provide multi-layered threat mitigation. Attributes of the data exchange transaction are individually tokenized with a checksum and priority to form a priority encrypted token. The encrypted tokens are validated by a security validation engine based on information stored in a centralized data storage repository and a number of security validation checks are assigned to be performed in a centralized secure access web gateway. Validated attributes are collected and decrypted to reconstruct the original data transaction information, which is then forwarded to an appropriate computing system for processing.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like). Aspects of the disclosure relate to computer hardware and software. In particular, one or more aspects of the disclosure generally relate to computer hardware and software to provide a tokenization-based data security mechanism.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes tokenization of attributes identified separately from each computing system involved in a data exchange transaction, validating the secure attributes from the generated tokens, and completing the data exchange transaction upon successful validation and decryption of the attribute information.

To resolve the problems identified above, a plurality of data exchange transactions, such as, for example, cloud-based point-of sale transactions, may be securely managed through an advanced attribute-prioritized checksum tokenization mechanism. This attribute-prioritized checksum tokenization mechanism may be integrated with a centralized secure access web gateway (CSAWG) for multi-layered threat mitigation. The threat mitigation mechanism for securing cloud-based data exchange transactions (e.g., cloud-based point-of-sale transactions, cloud-based data exchange transactions between remote computing systems, and the like) may be multi-layered.

A first layer may tokenize transaction attributes (e.g., for an electronic payment transaction the attributes may include payer, payee, amount, currency, payment method, and/or the like.) and encodes each attribute as a priority embedded token with due emphasis on hierarchical structure, preservation of inter-relationship. In a second layer these embedded tokens are validated by a security validation engine based on information stored in a centralized data storage repository and to provide for analysis the required validation checks needed in the CSAWG layer. In the third layer the properly validated embedded tokens will pass through the required number of validation stages in Centralized Secure Access Web Gateway (CSAWG). In a fourth layer, valid embedded tokens are reconstructed to original transaction attributes.

Thus, transaction data security is enhanced to prevent and/or detect fraudulent activities in the existing cloud-based computing systems (e.g., a cloud-based point-of-sale transaction network), as well as overcoming all the potential technical malfunctions in the existing system, as described above. A use case may include risky fraudulent details being detected by the CAWG network. This system may be leveraged in multiple data exchange systems including those that exchange date between different enterprise computing systems via a cloud-based network. For example, this system may be leveraged in an open distributed banking system. The improved security ensures that fraudulent activities will be largely reduced. Data security and data movements are further secured via the security validation engine. Additional validation techniques are provided by maintaining an attribute-prioritized checksum tokenization centralized data storage repository.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for a threat mitigation mechanism for cloud-based data exchange transactions, in accordance with one or more aspects described herein;

FIG. 1B shows an illustrative computing platform enabled for a threat mitigation mechanism for cloud-based data exchange transactions, in accordance with one or more aspects described herein;

FIG. 2 shows an illustrative process for an attribute-prioritized checksum tokenization mechanism that is integrated with a centralized secure access web gateway for multi layered threat mitigation, in accordance with one or more example arrangements; and

FIG. 3 shows an illustrative attribute-prioritized checksum tokenization comprising a centralized secure access web gateway for multi layered threat mitigation, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Presently data exchange transaction involving cloud-based computing systems may be subject to security breaches. In an illustrative example, enterprise organizations may perform data exchange transactions, such as a point-of-sale transaction via a cloud-based network. The cloud-based systems may be subject to security breaches with increasing frequency, where the intercepted data may then be accessible to nefarious actors, such as into the hands of hackers or other malicious users and/or may pave a path for improper or illegal use of the intercepted data, such as with deceitful transactions. In the illustrative example, of cloud-based point-of-sale transactions, problems encountered with cloud-based systems include unresponsiveness and/or slow performance due to network connectivity issues with each of a plurality of interconnected computing systems. Other problems may be due to software errors and/or crashes, hardware malfunctions, network connectivity issues, and the like. System connectivity issues may further include data access errors that may cause, in the case of an electronic transaction, a payment failure and/or incorrect inventory levels. System lockups and/or data loss or data corruption may also occur due to a number of factors.

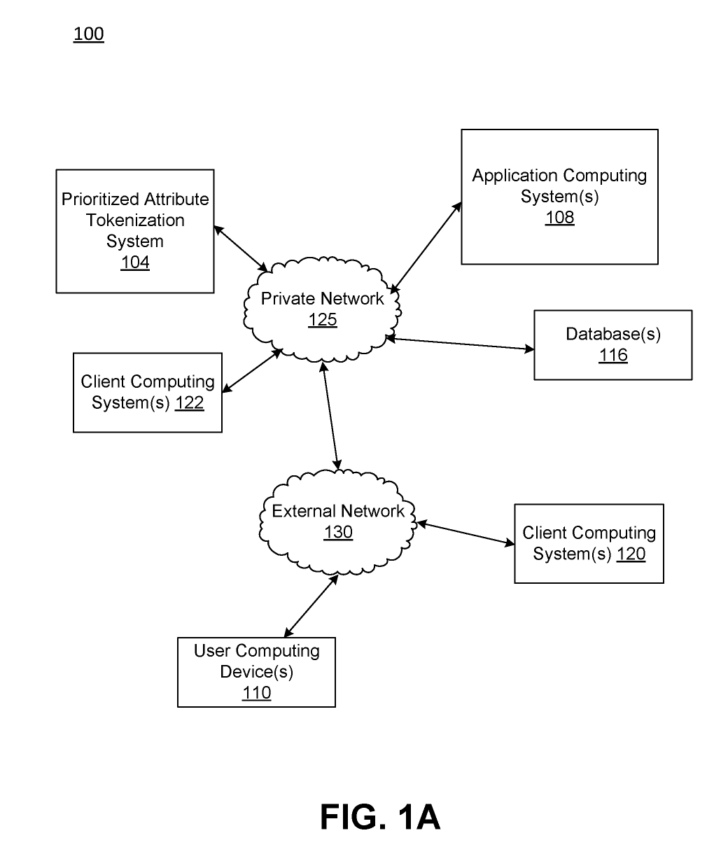

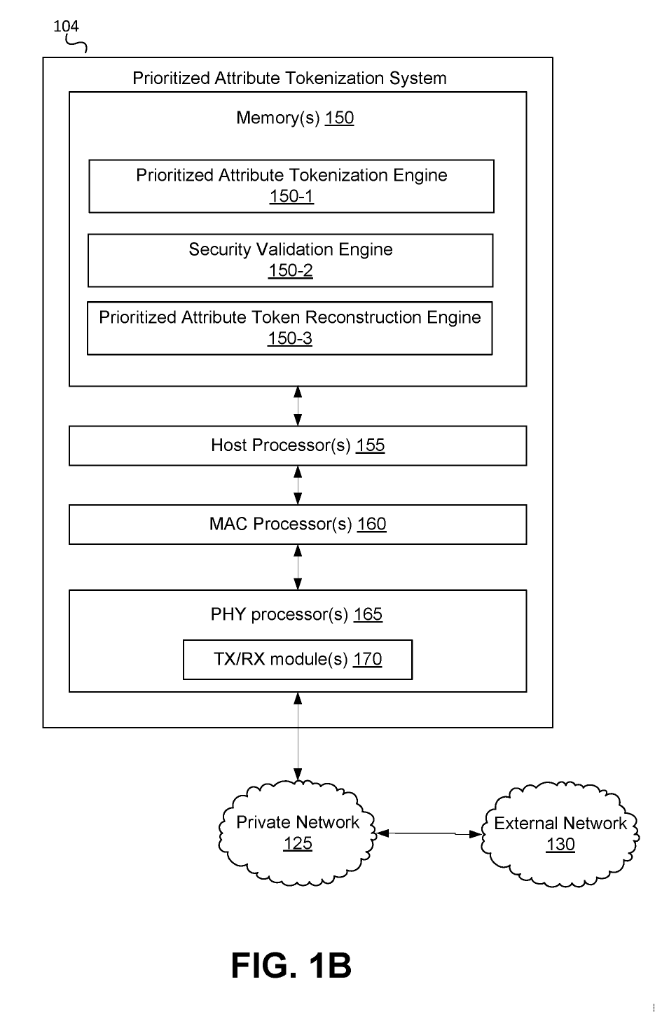

FIG. 1A shows an illustrative computing environment 100 for providing attribute-prioritized checksum tokenization via a centralized secure access web gateway for multi layered threat mitigation, in accordance with one or more arrangements. The computing environment 100 may comprise one or more devices (e.g., computer systems, communication devices, and the like). The computing environment 100 may comprise, for example, a prioritized attribute tokenization system 104, one or more application computing systems 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing systems 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the prioritized attribute tokenization system 104 as a stand-alone system, the prioritized attribute tokenization system 104 may be implemented as a portion of one or more different separate computing systems.

The prioritized attribute tokenization system 104 may comprise one or more computing devices and/or other computer components (e.g., processors, memories, communication interfaces) configured to perform one or more functions as described herein. Further details associated with the architecture of the prioritized attribute tokenization system 104 are described with reference to FIG. 1B.

The application computing systems 108 and/or the client computing systems 120, 122 may comprise one or more computing devices and/or other computer components (e.g., processors, memories, communication interfaces). In addition, the application computing systems 108 and/or the client computing systems 120, 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing system 120. In some cases, the client computing systems 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the prioritized attribute tokenization system 104. For example, the database(s) 116 may store attribute information, security information, tokenization information, encryption information, and the like. In an arrangement, the database(s) 116 may be used for other purposes as described herein. In some cases, the client computing systems 120 may write data or read data to the database(s) 116 via the services.

In one or more arrangements, the prioritized attribute tokenization system 104, the application computing systems 108, the client computing systems 122, the client computing systems 120, the user devices 110, and/or the other devices/systems in the computing environment 100 may be any type of computing device capable of receiving input via a user interface, and communicating the received input to one or more other computing devices in the computing environment 100. For example, the prioritized attribute tokenization system 104, the application computing systems 108, the client computing systems 122, the client computing systems 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the prioritized attribute tokenization system 104, the application computing systems 108, the client computing systems 122, the client computing systems 120, the user devices 110, and/or the other devices/systems in the computing environment 100 may, in some instances, be and/or comprise special-purpose computing devices configured to perform specific functions.

FIG. 1B shows an illustrative prioritized attribute tokenization system 104 in accordance with one or more examples described herein. The prioritized attribute tokenization system 104 may be a stand-alone device and/or may at least be partial integrated with the prioritized attribute tokenization system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The prioritized attribute tokenization system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the prioritized attribute tokenization system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the prioritized attribute tokenization system 104 may be configured to execute machine readable instructions stored in memory 150. The memory 150 may comprise (i) one or more program modules/engines having instructions that when executed by the one or more processors cause the prioritized attribute tokenization system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the prioritized attribute tokenization system 104 and/or by different computing devices that may form and/or otherwise make up the prioritized attribute tokenization system 104. For example, the memory 150 may have, store, and/or comprise a prioritized attribute tokenization engine 150-1, a security validation engine 150-2, a prioritized attribute token reconstruction engine 150-3, and/or the like. The prioritized attribute tokenization engine 150-1 may have instructions that direct and/or cause the prioritized attribute tokenization system 104 to perform one or more operations associated with identifying attributes of a data exchange transaction, generating a checksum and a priority score linked to the checksum, and encrypting the linked checksum and priority score to create a token, and the like. The security validation engine 150-2 may have instructions that may cause the prioritized attribute tokenization system 104 to analyze and categorize encrypted tokens with respect to information stored in a centralized database and allows validated tokens to pass through. The prioritized attribute token reconstruction engine 150-3 may have instructions that may cause the prioritized attribute tokenization system 104 to validate an embedded checksum within validated tokens and decrypt the tokenized attributes, and reconstruct a data exchange transaction to be completed based on the decrypted attributes, and communicating same to indicated enterprise computing systems to complete the data exchange transaction.

While FIG. 1A illustrates the prioritized attribute tokenization system 104 and the application computing systems 108, as being separate elements connected in the private network 125, in one or more other arrangements, functions of one or more of the above may be integrated in a single device/network of devices. For example, elements in the prioritized attribute tokenization system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

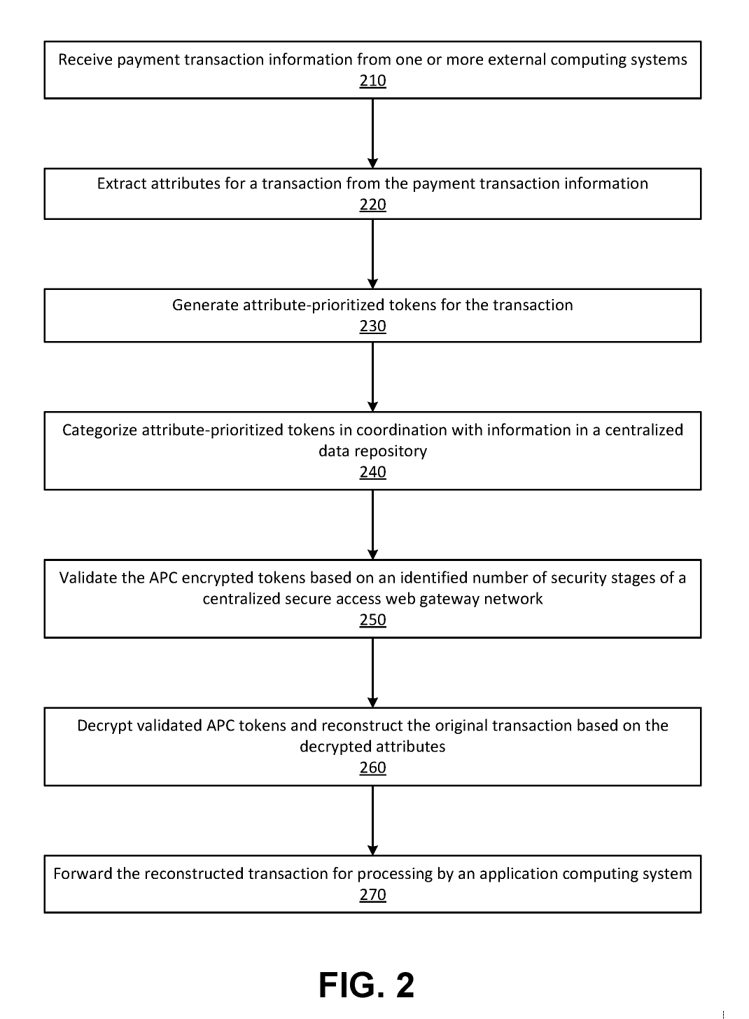

FIG. 2 shows an illustrative process for an attribute-prioritized checksum tokenization mechanism that is integrated with a centralized secure access web gateway for multi layered threat mitigation, in accordance with one or more example arrangements. At 210, the attribute-prioritized checksum tokenization system may receive payment transaction information from one or more external computing systems, such as a cloud-based point of sale system. At 220, the attribute-prioritized checksum tokenization system may extract attributes for a transaction associated with the payment transaction information received from the one or more data sources 310 of the transaction information and generate attribute-prioritized tokens corresponding to the transaction, where the payment transaction attributes (e.g., payer information, payee information, payment amount information, account information, date information, and/or the like) may be extracted from the transaction and linked to allow for future reconstruction of the transaction information following validation and analysis. At 230, the attribute-prioritized tokenization engine 320 may generate attribute prioritized tokens for each extracted attribute of the transaction.

At 240, the security validation engine 330 may categorized the attribute-prioritized tokens in coordination with information stored in a centralized data repository, such as the attribute-prioritized checksum tokenization centralized data storage repository 345. At 250, the APC encrypted tokens may be validated based on an identified number of security stages of a centralized secure accessed web gateway network 340. At 260, the validated APC encrypted tokens may be decrypted by an attribute-prioritized checksum token reconstruction engine 350 that then reconstructs the original transaction information from the attributes decrypted from the tokens. At 270, the reconstructed transaction information is forwarded to an enterprise network for further processing by an application computing system to process the communicated transaction. Details of the process are discussed below in greater detail.

Many points of failure for communication functions involved in cloud-based communications, such as cloud-based payment transactions. Such communication failures may include unresponsiveness, slow performance, software-induced errors, payment failures, system lockups, data loss, as well as data corruption. These describe some of the existing problems encountered when performing the cloud based point-of-sale (POS) transactions. The present disclosure provides a method and system providing a multi-layer mitigation mechanism to detect and prevent these threats to timely and secure communications of payment transactions. In an illustrative example, the multi-layer solution may include four primary layers.

In an illustrative example a first layer corresponds to an initial receipt of a payment transaction received via a POS terminal. Here, attributes of the payment transaction are first converted to tokenized transaction attributes where, based on their priority, an embedded checksum the tokens are encoded with an embedded hierarchical structure. The encoding is performed in a way to prevent the hierarchical structure and interrelationship among the individual tokens from being lost. For example, each individual attribute is encoded with a priority and linked to other attributes of corresponding to the same transaction. The resulting tokens with their embedded priorities, are then passed through a second layer. In this layer, communications are enhanced by using a security validation engine. For example, within the second layer, an analysis of the priority embedded tokens are performed and coordinated with a centralized data storage repository. The security validation engine then validates whether the tokens are valid and, based on a risk and a sensitivity associated with each attribute of the transaction data, the security validation engine analyzes a recorded validation record for the transaction to pass the corresponding attributes through in a third layer.

At the third layer, the embedded attribute tokens enter a centralized secure access web gateway. Further, based on the analysis performed in the first layer and the second layer, each attribute will pass through a recorded number of validation processes. Once all embedded tokens associated with a particular transactions complete all the validation steps, the valid and the verified tokens progress to a fourth layer. In the 4th layer, the verified attribute tokens are reconstructed to the original transaction attributes, which are then used to reconstruct the transaction which may then be passed to an appropriate enterprise application computing system for processing.

In general, with a real-time cloud-based transaction processing event, the system and methods of the present disclosure may operate to process transactions initiated from any point-of-sale computing device, such as a customer device transaction entry (e.g., an online transaction), a merchant point-of-sale device, and/or the like. From each POS transaction entry into a cloud-based communication network, the transaction includes multiple data attributes are generated to accurately describe the transaction details. Because of the sensitive nature of the transaction information (e.g., customer private information, merchant private information, account information, and/or the like)a risk exists that malicious actors may attempt to inappropriately access or otherwise intercept communications of the transaction information to allow for improper use of that information. The advanced attribute-prioritized checksum tokenization system provides an entire multi-layered framework to securely communicate encoded information to an enterprise organization, such as a financial institution, for processing and completion of the POS transaction without exposing the transaction information in a single communication to reduce a risk of exposure to malicious actors.

Within the advanced attribute-prioritized checksum tokenization system, each payment transaction received via a POS terminal (e.g., a POS terminal, an online transaction, and the like) is received by an attribute prioritized checksum (APC) tokenization engine. Once received, the APC tokenization engine, each attribute is converted to an embedded prioritized checksum token. Next, each embedded prioritized checksum token is received by a security validation engine that, with coordination with an APC tokenization centralized data repository, ensures that all tokens for the particular transaction, along with previous historical transactions, are available. The security validation engine compares the transaction's associated embedded prioritized checksum tokens with the available information in the APC tokenization centralized data repository to validate whether each token is a valid token. Based on a sensitivity and a risk of potential misuse of the attribute detailed information and/or the transaction information, the transaction detail, security validation engine assigns the record number of validations to be performed in the next layer by the centralized secure access web gateway. Once the centralized secure access web gateway completes all the validation steps for each tokenized transaction attribute, and all are validated, each embedded prioritized checksum token of the transaction attributes are passed to a reconstruction engine (e.g., the APC token reconstruction engine). The APC token reconstruction engine processes each validated APC token for the transaction to reconstruct the original transaction data, which can then be communicated to an appropriate application computing system for initiation of processing.

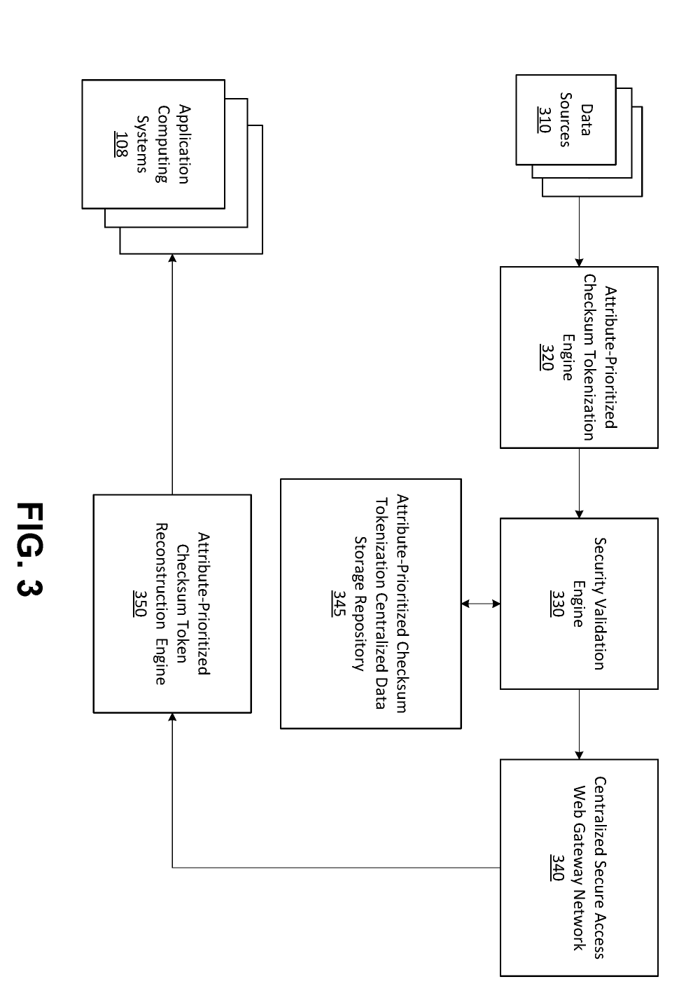

FIG. 3 shows an illustrative attribute-prioritized checksum tokenization system comprising a centralized secure access web gateway for multi layered threat mitigation, in accordance with one or more aspects described herein. Source data, such as payment transactions run through a point-of-sale terminal, via mobile applications, computer applications and/or any e-commerce sites may flow through an attribute prioritized checksum (APC) tokenization engine.

The APC tokenization engine focuses on key transaction attributes (e.g., payer, payee, amount, currency, payment method, and the like) as individual tokens and encodes them to generate the checksum using a cryptographic hash (e.g., a SHA-256 algorithm). Further, each token carries a priority score based on its importance in the transaction, which is dynamically linked with its corresponding checksum. Upon analyzing the priority of tokens, they are again encrypted and compressed with combination of one or more encryption algorithms (Advanced Encryption Standard (AES) ,Elliptic Curve Cryptography(ECC), Rivest-Shamir-Adleman (RSA), hybrid encryption algorithms etc.) . The APC encrypted tokens are passed to the next stages.

A security validation engine isolates the valid transactions to be passed to the next layer. The security validation engine analyzes and categories the encrypted tokens with respect to information stored in the attribute-prioritized checksum tokenization centralized data storage repository and allows the valid APC encrypted tokens to pass through the required number of stages in a CSAWG Network based on its sensitivity of the transaction attributes.

The CSAWG network converges networking and security functions in the cloud including SD-WAN and cloud native security functions such as secure web gateways, cloud access security brokers, firewall as-a-service, and zero-trust network access that connect users to the applications and data they need. Based on the security validation engine analysis, the APC encrypted tokens will pass through the required number of stages and the successful tokens are allowed for further processing.

The attribute-prioritized checksum tokenization centralized data storage repository manages all the transaction details with key attributes in encrypted token formats along with the history of all past transactions. It is updated with latest transaction details after every transaction.

The APC encrypted tokens that pass the CSAWG network validations are then reconstructed into original transaction attributes by validating the embedded checksum integrity and decrypted using the one or more combinations of decryption algorithms (AES,ECC, RSA, hybrid decryption algorithms etc.). Once decrypted, the transaction information may be forwarded to the indicated computing systems for completion of the transactions, such as to one or more of the application computing systems 108, the client computing systems 120, and/or the client computing systems 122.

In an illustrative example, a transaction may be initiated at a point-of-sale device with four attributes (e.g., payer, payee, amount, and date). The APC Tokenization Engine may focus on the key transaction attributes (e.g., payer, payee, amount, currency , payment method, and the like) as individual tokens and may encode the extracted attributes to generate a checksum using a cryptographic hashing algorithm (e.g., SHA-256 algorithm). Further, each token carries a priority score based on its importance in the transaction, which is dynamically linked to each attribute with its corresponding checksum. A sample token generation by the APC tokenization engine 320 may extract four transaction attributes as inputs, Payer : XXX , Payee: YYY, Amount: $4000, and Date: Dec.12, 2024. The APC tokenization engine 320 may generate tokenized output that comprise an attribute identifier, attribute data, a priority, and a checksum. In the illustrative example, the tokenized output comprises [“Payer|XXX|2|CHKSM120EA3456HY…”, “Payee|YYY|2|CHKSM789EA35I6HY…”, “Amount|$4000|1|CHKSM897E56O…”, and “Date|Dec.12, 2024|3|CHKSMY7845KL7895…”]. Upon analyzing the priority of the attribute tokens, they are further encrypted and compressed with combination of one or more encryption algorithms such as Advanced Encryption Standard (AES) ,Elliptic Curve Cryptography(ECC), Rivest-Shamir-Adleman (RSA), hybrid encryption algorithms, and the like. These APC encrypted tokens are passed to the next stages of the process.

When assigning priorities, the APC tokenization engine 320 may analyze the attributes to identify an importance of the attributes. In the illustrative example, the payment amount is the highest priority and is assigned a priority of "1", the payer/payee attributes are the next higher priority and are each assigned a priority of "2", and the date of the transaction is the lowest priority and is assigned a priority of "3". While the illustrative example, includes four attributes, a transaction may have "n" attributes. The APC tokenization engine 320 may then generate and associate a checksum for each attribute. The checksum is unique for each attributes and is dynamically connected to the attribute. The checksum may be generated as a combination of information corresponding to the attribute such as the attribute name, the attribute value, and the assigned priority. Additionally, a transaction ID may further be included in the information used to generate the checksum to link all associated attributes to the corresponding transaction. As such, the checksum is unique for each attribute and corresponds to the individual tokens based on the checksum and are identified based on checksum and the priority score generated by the APC tokenization engine 320. Further based on this priority score, the APC tokenization engine 320 will encrypt and compress the individual token based on the risk and sensitivity of the data. The APC tokenization engine 320 may encrypt and compress each attribute based on a single encryption algorithm or a combination of multiple encryption algorithms based on the risk and sensitivity of the data. These encrypted tokens are then communicated for further validation.

As mentioned, each attribute prioritized checksum token is dynamically linked to other related tokens based on the checksum calculated for each individual token. As such, the output of the APC tokenization engine 230 is fed to the security validation engine 330 and the APC tokenization centralized data storage repository 345 that manages all the transaction data with key attributes in encrypted token format. Along with that, the APC tokenization centralized data storage repository 345 stores historical transaction information. For example, after completion of every transaction, the APC tokenization centralized data storage repository 345 is updated with the final transaction information and/or an indication of whether the transaction completed successfully, was subject to improper activities, and the like. The security validation engine 330 process attribute tokes of valid transactions to be passed to the next layer. The security validation engine 330 analyzes and categories the encrypted tokens with information stored in the APC tokenization centralized data storage repository 345 and allows the valid APC encrypted tokens to pass through the required number of stages in a centralized secure access web gateway network 340 based on its sensitivity of the transaction attributes.

The security validation engine 330 compares the encrypted token received from APC tokenization engine 320 with information stored in the centralized data storage repository to confirm the tokens are valid as a first step of confirming the validity of the encrypted token. Second, the security validation engine 330 analyzes a risk and sensitivity of the data. Based on that analysis, the security validation engine 330 identifies, for each APC token, whether the corresponding transaction is a high risk transaction, a high value transaction, a medium value transaction, a low value transaction, and/or the like. Based on this determination, the security validation engine 330 determines a number of validation checks to be passed in the next layer, the centralized secure access web gateway network 340. For example, if the security validation engine 330 identifies an attribute as part of a high value transaction, a high risk transaction, and/or a high priority transaction, the security validation engine 330 assigns a high number of security check stages to pass within the centralized secure web gateway network 340. Similarly, for a medium risk transaction and/or medium sensitivity data, the security validation engine 330 may assign a subset of the security checks (e.g. three out of five, four out of five, and the like). In some cases, the security validation engine 330 may assign a combination of two or three stages. If a risk is determined to be of very low risk and/or low normal cash flow transaction, the security validation engine 330 may assign a single stage or a combination of two stages.

The centralized secure access web gateway network 340 converges networking and security functions available in the cloud including software defined (SD)-WAN and/or cloud native security functions, such as secure web gateways, cloud access security brokers, firewall as-a-service, and zero-trust network access which connect users to the applications and data as required. Based on analysis performed by the security validation engine 330, the APC encrypted tokens will pass through the required number of stages of the security functions provided via the centralized secure access web gateway network 340. If a transaction is high risk and highly sensitive, the security validation engine 330 may assign a combination of three or more of the networking and security functions. For example, in some cases, the security validation engine 330 may assign a zero-trust network access protocol to validate all the transaction attributes for their identity as well as for any data breaches that must be prevented. Further, if the attribute is required to be monitored and to control activity in a cloud application, the security validation engine 330 may assign the attribute to be processed via a cloud access security broker network. If the attribute is the transaction request, the security validation engine that may be subject to firewall breaches, then the security validation engine 330 may assign a firewall-as-a-service to process the attribute token, and/or the like.

Based on the analysis of the risk and sensitivity of the transaction, a number of validations to be passed within the centralized secure access web gateway network 340 is assigned by the security validation engine 330 and the validated tokens will then be processed by and/or pass through the assigned number of stages in the centralized secure access web gateway network 340. Upon the validation in the centralized secure access web gateway network 340, the validated tokens are allowed to pass through to the APC token reconstruction engine 350. As a note, each attribute token is analyzed separately such that for a high value transaction, all associated attribute tokens are individually assigned a number of stages within the centralized secure access web gateway network 340 to be passed. This determination is determined based on which attribute is creating the risk to the transaction, the relationship of that risk with the historical data. Based on that, regardless of whether the transaction is high value, medium value, or low value, all of the tokenized attributes may suggest a different level of risk that may be based on all other attribute parameters (e.g., an origination method of the transaction, an origination location of the transaction, and/or a combination of other attributes) may further factor into the determination of the validation processes within the centralized secure access web gateway network 340.

Each attribute is considered separately while determining the risk, but when the actual validation happens, the validation occur and may refer back to multiple attributes. For example, the processes might refer back to an attribute based on a risk outline that has been determined based on the attribute analysis.

For example, the POS system may have received a transaction at an odd time. The time itself may not be enough to for elevated risk, but in combination with an amount of the transaction, these two attributes, when considered together, may generate a specific risk, which is the reason for the need to validate that the origination of the transaction and/or the source of the transaction is accurate. To validate that source of the transaction it has to go through this particular validation.

The validated and verified token from the centralized secure access web gateway network 340, next is fed into the APC tokenization reconstruction engine 350. When all associated encrypted tokens associated with a corresponding transaction are validated and verified, the transaction attributes are decrypted and reconstructed to original token attributes based on the same encryption algorithm that is sued for decryption. Output of the APC tokenization reconstruction engine 350 is transaction information the same as that of the transaction data that was fed into the APC tokenization engine 320. Once reconstructed, the transaction now has been security communicated to the enterprise network for validation by an appropriate application computing system.

The APC tokenization system provides a new mechanism for attribute prioritized checksum tokenization, as well as for reconstruction of the attributes from the tokens once validated and communicated through the network. In doing so, communications of the transaction information is secure in that all attributes are separately tokenized, analyzed, and validated to enhance fraud mitigation of and provides increased data integrity. As such, no direct security breaches can occur during this communication method because of this individual APC tokenization and validation. Second, the APC tokenization system provides risk-based and sensitivity-based analysis for encryption and tokenization and assigning numbers of security validation processes to be performed and validations to be performed at the centralized secure access web gateway network 340. The use of the centralized secure access web gateway network 340 provides immunity to cyber-attacks and/or possible use for fraudulent transactions. Based on the links between attributes with the encrypted checksums, the original transaction information may be reconstructed to allow for proper processing of the transaction. Further, because all transaction attributes are analyzed independently, secure communication of the transaction information between the cloud-based inputs (e.g., POS system) and the processing system of the enterprise network due to only subjecting the higher risk/sensitive attributes to the most rigorous analysis.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system comprising:
a first computing system processing instructions to provide a user interface, wherein the user interface facilitates a data exchange transaction;
a computing platform, comprising:
at least one processor; and
memory storing computer-readable instructions that, when executed by the at least one processor, cause the computing platform to:
receive, from the first computing system via a network, transaction information corresponding to the data exchange transaction, wherein the transaction information comprises a plurality of attributes;
extract, by an attribute-prioritized checksum (APC) tokenization engine, the plurality of attributes from the transaction information;
tokenize, by the APC tokenization engine, each attribute of the plurality of attribute to generate a plurality of APC tokens;
assign, via a risk assessment and by a security validation engine, a number of security validation tests to be performed for each APC token of the plurality of APC tokens;
validate, by a centralized secure access web gateway network and based on the number of security validation tests assigned by the security validation engine, each APC token of the plurality of APC tokens;
reconstruct, based validation of the plurality of APC tokens, the data exchange transaction from each decrypted APC token of the plurality of APC tokens; and
send, via an enterprise network, the transaction information to an application processing system.

2. The system of claim 1, wherein the user interface comprises a point-of-sale system communicating via a cloud-computing network.

3. The system of claim 1, wherein the data exchange transaction comprises a payment transaction.

4. The system of claim 1 wherein tokenization each attribute of the plurality of attributes comprises:
determining a priority of each attribute of the plurality of attributes; and
calculating a checksum based on an attribute name, an attribute value, and the priority.

5. The system of claim 4, wherein calculation of the checksum further comprises calculating the checksum based on a transaction checksum of the data exchange transaction.

6. The system of claim 4, wherein the plurality of attributes comprises a transaction source attribute, a transaction destination attribute, a transaction data attribute, and a date attribute.

7. The system of claim 6, wherein the data exchange transaction comprises a payment transaction, the transaction source attribute comprises a payer attribute, the transaction destination comprises a payee attribute, and a transaction data attribute comprises a transaction value attribute.

8. The system of claim 7, wherein the instructions further cause the computing platform to decrypt each APC token of the plurality of APC tokens based on validation of each APC token of the plurality of APC tokens.

9. The system of claim 1, wherein the security validation tests assigned by the security validation engine comprises one or more cloud-based security functions.

10. The system of claim 9, wherein the cloud-based security functions comprise one or more of a software-defined wide area network, a secure web gateway, a cloud access security broker, a firewall as-a-service, and a zero-trust network access system.

11. The system of claim 1, further comprising the application processing system, wherein the application processing system processes instructions that cause the application processing system to:
receive, from the computing platform, the transaction information; and
execute, based on the transaction information, the data exchange transaction.

12. A computing platform comprising:
at least one processor; and
memory storing computer-readable instructions that, when executed by the at least one processor, cause the computing platform to:
receive, from a first computing system via a network, transaction information corresponding to a data exchange transaction, wherein the transaction information comprises a plurality of attributes corresponding to inputs entered via a user interface;
extract, by an attribute-prioritized checksum (APC) tokenization engine, the plurality of attributes from the transaction information;
tokenize, by the APC tokenization engine, each attribute of the plurality of attribute to generate a plurality of APC tokens;
assign, via a risk assessment and by a security validation engine, a number of security validation tests to be performed for each APC token of the plurality of APC tokens;
validate, by a centralized secure access web gateway network and based on the number of security validation tests assigned by the security validation engine, each APC token of the plurality of APC tokens;
reconstruct, based validation of the plurality of APC tokens, the data exchange transaction from each decrypted APC token of the plurality of APC tokens; and
send, via an enterprise network, the transaction information to an application processing system to execute the data exchange transaction.

13. The computing platform of claim 12, wherein a user interface comprises a point-of-sale system communicating via a cloud-computing network.

14. The computing platform of claim 12, wherein the data exchange transaction comprises a payment transaction.

15. The computing platform of claim 12 wherein tokenization each attribute of the plurality of attributes comprises:
determining a priority of each attribute of the plurality of attributes; and
calculating a checksum based on an attribute name, an attribute value, and the priority.

16. The computing platform of claim 15, wherein calculation of the checksum further comprises calculating the checksum based on a transaction checksum of the data exchange transaction.

17. The computing platform of claim 15, wherein the plurality of attributes comprises a transaction source attribute, a transaction destination attribute, a transaction data attribute, and a date attribute.

18. The computing platform of claim 17, wherein the data exchange transaction comprises a payment transaction, the transaction source attribute comprises a payer attribute, the transaction destination comprises a payee attribute, and a transaction data attribute comprises a transaction value attribute.

19. The computing platform of claim 18, wherein the instructions further cause the computing platform to decrypt each APC token of the plurality of APC tokens based on validation of each APC token of the plurality of APC tokens.

20. The computing platform of claim 12, wherein the security validation tests assigned by the security validation engine comprises one or more cloud-based security functions.
